(19) United States
(12) Patent Application Publication
(10) Pub. No.: US 2021/0025374 A1
(43) Pub. Date: Jan. 28, 2021

(54) Hydraulic Pressurizing Medium Supply Assembly, and Method

(71) Applicant: Robert Bosch GmbH, Stuttgart (DE)

(72) Inventors: Florian Muehlbauer, Neu-Ulm (DE); Michael Brand, Ulm (DE); Minha An, Weissenhorn (DE); Salih Tetik, Nersingen (DE); Ximing Wang, Neu-Ulm (DE)

(21) Appl. No.: 16/938,373

(22) Filed: Jul. 24, 2020

(30) Foreign Application Priority Data
Jul. 26, 2019 (DE) 10 2019 120 330.9
Aug. 27, 2019 (DE) 10 2019 212 845.9

(51) Int. Cl. F04B 1/324; F04B 49/08

(52) U.S. Cl. CPC F04B 1/324; F04B 49/002; F04B 49/08

(57) ABSTRACT

A hydraulic pressurizing medium supply assembly includes a hydro machine which has an adjustable swash plate. An angle of the swash plate is able to be adjusted by way of a pilot valve. The pilot valve is able to be adjusted by a control. When the pilot valve is actuated by a neutral current, a valve slide of the pilot valve assumes a central position in which the swash plate does not perform any movement. In order for the pilot valve to be controlled it is provided that the control emits a control variable. The control variable, at the outlet side of the control, is linked and adapted to a preliminary control variable for the neutral current, in order for the neutral current to be pre-controlled.

This application claims priority under 35 U.S.C. § 119 to (i) patent application no. DE 10 2019 120 330.9, filed on Jul. 26, 2019 in Germany, and (ii) patent application no. DE 10 2019 212 845.9, filed on Aug. 27, 2019 in Germany. The disclosures of the above-identified patent applications are both incorporated herein by reference in their entirety.

The disclosure relates to a hydraulic pressurizing medium supply assembly for a hydraulic circuit, for example for mobile work machines. The disclosure furthermore relates to a method for a hydraulic pressurizing medium supply assembly.

### BACKGROUND

A pressure and flow control system is known from document RD 30630/04.13 of the Rexroth company. Said pressure and flow control system serves for the electro-hydraulic control of a swivel angle, pressure and power of an axial piston variable-displacement pump. The control system has an axial piston variable-displacement pump with an electrically actuated proportional valve. A set piston can be actuated by way of said proportional valve. Said set piston serves for adjusting a swash plate of the variable-displacement pump. A displacement transducer by way of which a swivel angle of the swash plate can be determined by way of the displacement path of the set piston is provided for the set piston. As an alternative to the displacement transducer, a swivel angle of the swash plate can also be detected on the pivot axle by way of a Hall sensor. The volumetric flow of the variable-displacement pump can in turn be ascertained from the swivel angle of the swash plate. The variable-displacement pump is driven by a motor. When the variable-displacement pump is not being driven and pressure is absent in the actuating system, the variable-displacement pump, on account of a spring force of a spring, pivots toward a maximum delivery volume. In contrast, the variable-displacement pump in the driven state of the variable-displacement pump and with a non-energized pilot valve and a closed pump outlet pivots toward a zero-stroke pressure. An equilibrium between the pump pressure at the set piston and the spring force of the spring is established at approximately 4 to 8 bar. The initial position is usually assumed when the control electronics are de-energized. A control system for the pilot valve as an input variable has a nominal pressure, a nominal swivel angle, and optionally a nominal output value. An actual pressure at the outlet side of the variable-displacement pump is detected by a pressure sensor. As has been explained above, an actual swivel angle is ascertained by way of the displacement transducer. The recorded actual values are digitally processed in an electronics unit and compared with the predefined nominal value. A minimum value generator then automatically ensures that only the controller assigned to the desired operating point is active. An output signal of the minimum value generator in this instance is a nominal value for a proportional solenoid on the pilot valve. A displacement path of a valve slide of the pilot valve is detected by way of a displacement transducer and relayed to the control system in order for the pilot valve to be controlled. External control electronics are disclosed for the described adjustment of the axial piston variable-displacement machine in document RD 30242/03.10 of the Rexroth company. An electro-hydraulic control system is furthermore disclosed in document RD 92 088/08.04 of the Rexroth company.

A control system for alternatingly controlling a pressure and a conveyed flow is disclosed in EP 1 460 505 A2. A pivotable hydraulic axial piston variable-displacement machine which by way of a drive shaft is connected to a further hydro machine is provided here. A closed-loop control circuit for a drive torque of the variable-displacement machine is furthermore provided. The variable-displacement machine is supplied an actual drive torque and a nominal drive torque from which a control variable for an actuating installation of the variable-displacement machine is determined. The nominal drive torque in turn is an output variable of a minimum value generator. The latter herein selects an output variable of a pressure controller and of a volumetric flow controller. The volumetric flow of the hydro machine connected to the variable-displacement machine is provided as the actual volumetric flow herein. A high pressure of this hydro machine is furthermore provided as the actual pressure.

A hydro machine with a swivel angle sensor and a pressure sensor is furthermore disclosed in each of documents EP 2 851 565 B1, U.S. Pat. Nos. 4,801,247, 5,182,908, EP 0 349 092 B1, U.S. Pat. Nos. 5,267,441, 5,967,756 and 5,170,625.

The pressure, the volumetric flow, and the output can be controlled.

### SUMMARY

In contrast, the disclosure is based on the object of achieving a hydraulic pressurizing medium supply assembly which is able to be controlled in a simple manner and/or in which vibrations during the operation are minimized or even prevented. The disclosure is furthermore based on the object of achieving a simple method for the hydraulic pressurizing medium supply assembly, said method leading to an improvement of the actuating behavior.

According to the disclosure, hydraulic pressurizing medium supply assembly for an open hydraulic circuit which is in particular used for mobile work machines is provided. The pressurizing medium supply assembly can have a hydro machine, the delivery volume or the swept volume of the latter being able to be adjusted by way of an adjusting mechanism. The hydro machine is, for example, an axial piston machine having a swivel cradle or an adjustable swash plate, or an axial piston machine of the oblique-axle construction type. The adjusting mechanism preferably has an actuating cylinder having a set piston for adjusting the delivery volume or the swept volume of the hydro machine. The actuating mechanism furthermore preferably has a pilot valve which is electrically actuatable in a proportional manner. An inflow to and/or an outflow from a control chamber of the actuating cylinder that is limited by the set piston can be able to be controlled by way of said pilot valve. This serves for actuating the set piston in that the latter is able to be impinged with pressurizing medium. The pressurizing medium supply assembly can furthermore have an electronic control for the pilot valve. Said electronic control preferably has a controller with an output variable in the form of a control variable for the pilot valve, in particular for an actuator of the pilot valve. It can be provided that the valve slide of the pilot valve at a specific neutral current, in particular for the actuator of said valve slide, or at a specific actuating signal assumes a central position. In the central position it is advantageously provided that the set piston does not perform any movement, on account of which a stationary state of the hydro machine or of the pressurizing medium supply assembly can prevail. In other words, it is provided in the pilot valve that the valve slide at a specific actuating signal or neutral current assumes a central position at which the set piston of the hydro machine actuated therewith does not perform any movement. A preliminary control variable for the neutral current is preferably linked to the control variable at the output side of the controller or at the output of the latter. This serves for pre-controlling the neutral current. In other words, a preliminary control variable for the neutral current is linked to the control variable of the controller at the output side of the controller in order for the control variable for the pilot valve to be set.

This solution has the advantage that the controller has to emit only the “net signal” for the adjustment of the swivel angle or of the delivery volume for the hydro machine. An actuating signal, or the neutral current for the central position of the valve slide, respectively, is predefined and the controller output thus does not have to be subjected to any variation without this resulting in an effect on the closed-loop control system. It has also been demonstrated that a vibration behavior of the pressurizing medium supply assembly is significantly improved on account thereof. No or comparatively minor vibrations arise in the controlling operation at the pressurizing medium supply assembly. Precise pre-controlling of the neutral current is furthermore advantageous in order for a required dynamic characteristic of the pressurizing medium supply assembly to be achieved.

In a further design embodiment of the disclosure it can be provided that the control for the preliminary control variable has a control element which determines the preliminary control variable by means of a characteristics map. This has the advantage that the preliminary control variable for example in this instance as a function of an operating state of the pressurizing medium supply assembly can be determined by way of the characteristics map. It is conceivable in this instance that at least a state variable or an actual variable of the pressurizing medium supply assembly is provided as an input variable for the control element.

In a further preferred design embodiment of the disclosure it can be provided that the characteristics map and/or the preliminary control variable are/is adaptable or correctable. This is extremely advantageous since positions of the valve slide, for example the central position, of the pilot valve may vary when identically energized, in particular over the period of use following a commissioning of the pressurizing medium supply assembly. The variation usually depends on various parameters and is inter alia also caused by age and wear. The neutral current can be adapted to variable conditions by adaptation. It is thus conceivable, for example, that the neutral current is initially calibrated when commissioning the pressurizing medium supply and is then able to be adapted or corrected when required. In other words, the adaptation of the characteristics map and/or of the preliminary control variable is advantageous since the neutral current varies as a function of the operating state of the pressurizing medium supply assembly (actual outlet pressure, actual temperature, actual rotating speed) and is subject to variance, in particular on account of ageing and of production tolerances of the valve slide of the pilot valve, of the solenoid, and of the spring.

A one-dimensional or a multi-dimensional characteristics map is provided as a characteristics map, for example. The characteristics map can be configured as a neutral current curve, for example. An actual outlet pressure and/or an actual rotating speed and/or an actual swivel angle of the hydro machine and/or an actual temperature of a pressurizing medium of the hydro machine are/is conceivably to be provided as a dimension/dimensions of the characteristics map. For example, if the actual outlet pressure is provided as a dimension, the neutral current as a function of said actual outlet pressure can thus be derived from the characteristics map.

In a further design embodiment of the disclosure it is conceivable that the controller is provided for controlling an actual delivery-volume adjustment rate or for controlling an actual swivel-angle adjustment rate of the hydro machine. The actual delivery-volume adjustment rate or the actual swivel-angle adjustment rate, in particular as a derivation of the actual delivery volume or of the actual swivel angle, and a nominal delivery-volume adjustment rate or a nominal swivel-angle adjustment rate of the hydro machine, can be provided as an input variable. The control variable for the pilot valve can serve as an output variable. The controller which controls the delivery-volume adjustment rate or the swivel-angle adjustment rate can pre-control the neutral current at the output by way of the preliminary control variable so that the controller has to emit only the net signal for the adjustment of the swivel angle or of the delivery volume of the hydro machine.

The controller for the actual delivery-volume adjustment rate or the actual swivel-angle adjustment rate of the hydro machine is configured as a PI-controller, for example. If no adaptation of the characteristics map were to take place, a deviation of the characteristics map or of the neutral current characteristics map from the actual neutral current would be compensated for by the I-proportion in the controller or in the internal swivel-angle closed-loop control system. However, an I-proportion conceived in such a manner leads to overshooting in the control actions. Precise pre-controlling of the neutral current at an ideally minor I-proportion can thus advantageously take place by the adaptation, this leading to an extremely advantageous dynamic reaction of the hydro machine and to less overshooting. The reason therefore lies in that the I-proportion is no longer relevant when the operating point, thus the actual swivel angle or the actual outlet pressure, for example, and a dead path/dead time would be created in the output of the controller until the I-proportion is adapted.

According to the disclosure, a method for a hydraulic pressurizing medium supply assembly according to one or a plurality of the preceding aspects is provided, wherein the method comprises the following step:
linking the preliminary control variable for the neutral current and the control variable in order to pre-control the neutral current.

In a further design embodiment of the method, the following steps can be provided:
determining a stationary operating state or an operating point or an actual state of the pressurizing medium supply assembly by way of the control;
adapting the preliminary control variable and/or the characteristics map based on the stationary operating state. It can in particular be provided that the adaptation of the preliminary control variable and/or of the characteristics map takes place based on the control variable which is emitted by the control in the stationary operating state.

This solution has the advantage that automatic updating or adapting of the characteristics map for the neutral current is enabled. Should a PI-controller be used, the I-proportion can thus be kept minor and the control behavior of the hydro machine can be improved. All variances and tolerances can in this instance be automatically compensated for.

The adapting of the preliminary control variable and/or the characteristics map preferably takes place in such a manner that in the stationary operating state the control variable in a central position of the valve slide of the pilot valve is zero or is substantially zero.

In a further design embodiment of the method it can be provided that, should the control variable in the stationary operating state deviate from zero and thus as an error value be controlled into the neutral current, the control variable as an error value is offset against the preliminary control variable and/or the characteristics map. The preliminary control variable and/or the characteristics map can thus be adapted in a simple manner in that the control variable in the stationary operating state is considered to be an error value. For example, a subtraction of the control variable as an error value from the preliminary control variable and/or the characteristics map is provided as an offset. For example, the control variable as an error value can be subtracted from an interpolation point of the characteristics map, in particular in the form of the neutral current curve. That point of the characteristics map that has the smallest spacing from the stationary operating state is selected as the interpolation point, for example. It would also be conceivable for the closest interpolation points to be considered in a weighted manner as a function of the spacing of said interpolation points from the operating state.

In other words, it can be provided that a detection of the pump state or of the hydro machine state initially takes place. A stationary operating point and the position thereof in the characteristics map can be determined. The determination of a neutral current from the nominal characteristics map or from the characteristics map applicable to date then subsequently takes place. A new characteristics map or a new value can then subsequently be acquired in the preliminary control. An evaluation of the machine status can thus be initially provided in that a determination of operating points or stationary points takes place. Subsequently, an allocation of the operating point or of the operating points to an interpolation point or to a plurality of interpolation points in the characteristics map can be provided. In the process of changing the values of the characteristics map, the characteristics map is initially updated and a new characteristics map is then emitted.

It is conceivable for the adaptation of the characteristics map and/or of the preliminary control value to be repeated at regular intervals and/or continuously. The adaptation then takes place in particular when a stationary operating state prevails, for example when the actual swivel angle and the actual outlet pressure of the hydro machine are constant. A stationary operating state in which the derivation of the swivel angle is zero or less than a defined value can be identified in order for the neutral current curve, or the characteristics map, respectively, to be adapted. The signal proportion which as an error is then contributed by the controller or by the PI control element toward the neutral current is then subtracted as an error from the neutral current curve or from the characteristics map. The error is in particular subtracted from the interpolation point of the neutral current curve that corresponds to the stationary operating state. The characteristics map can be displaced on account thereof, for example.

An adaptation of the characteristics line is disclosed in DE 10 2014 225 147, for example. A characteristics line of a pump which has a hydro-mechanical EP controller is adapted therein. A specific valve actuating signal in this instance results in a specific swivel angle. This can be pre-controlled by means of a characteristics line in an electronic control apparatus. Said characteristics line is repeatedly adapted in the running operation.

Disclosed is a hydraulic pressurizing medium supply assembly having a hydro machine which has an adjustable swash plate. An angle of the swash plate is able to be controlled by way of a pilot valve. The pilot valve is able to be actuated by way of a control. When the pilot valve is actuated by a neutral current, a valve slide of the pilot valve thus assumes a central position in which the swash plate does not perform any movement. In order for the pilot valve to be controlled it is provided that the control emits a control variable. The control variable at the outlet side of the control herein is linked and adapted to a preliminary control variable for the neutral current, in order for the neutral current to be pre-controlled.

### BRIEF DESCRIPTION OF THE DRAWINGS

Preferred exemplary embodiments of the disclosure will be explained in more detail hereunder by means of schematic drawings in which:

FIG. 1 in a schematic illustration shows a hydraulic pressurizing medium supply assembly according to a first exemplary embodiment;

FIG. 2 in a schematic illustration shows a control for the pressurizing medium supply assembly from FIG. 1;

FIG. 3 in a schematic illustration shows a control for the pressurizing medium supply assembly from FIG. 1, according to a further exemplary embodiment;

FIG. 4 in a schematic illustration shows an adaptation of a characteristics map for a neutral current;

FIG. 5 shows a flow diagram for a method for the hydraulic pressurizing medium supply assembly according to one exemplary embodiment; and

FIG. 6 schematically shows a characteristics map for a neutral current, wherein an actual outlet pressure of the hydro machine is provided on the abscissa and the neutral current is provided on the ordinate.

### DETAILED DESCRIPTION

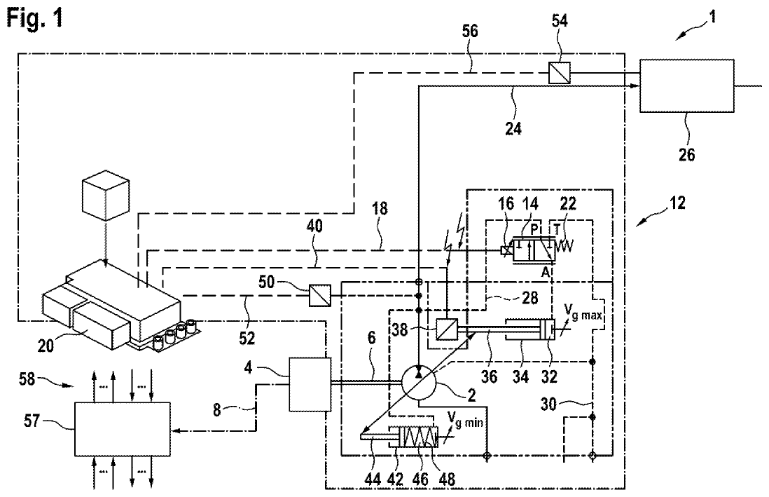

Shown according to FIG. 1 is a hydraulic pressurizing medium supply assembly 1 which has a hydro machine in the form of an axial piston machine 2. Said axial piston machine 2 has a swivel cradle for adjusting a delivery volume. The axial piston machine 2 can be used as a pump as well as a motor. The axial piston machine 2 is driven by a drive unit 4 which can be, for example, an internal combustion engine such as, for example, a diesel engine, or an electric motor. The axial piston machine 2 is connected to the drive unit 4 by way of a drive shaft 6. A rotating speed 8 of the drive shaft 6 can be detected by way of means not illustrated, for example by way of a speed sensor, and be supplied to a control of the pressurizing medium supply assembly 1. An adjusting mechanism 12 is provided for the axial piston machine 2. Said adjusting mechanism 12 has a pilot valve 14. The valve slide of said pilot valve 14 is electrically actuatable in a proportional manner by way of an actuator 16. To this end, the actuator 16 is supplied a control variable 18 by a control 20. The valve slide of the pilot valve 14 in the direction of an initial position is impinged with a spring force of a valve spring 22. The spring force acts counter to the actuating force of the actuator 16.

The axial piston machine 2 at the outlet side is connected to a pressure line 24 which in turn is connected to a main control valve 26 or valve block. The pressurizing medium supply between the axial piston machine 2 and one or a plurality of consumers can be controlled by way of said main control valve 26. A control line 28 which is connected to a pressure connector P of the pilot valve 14 branches off from the pressure line 24. The control line 28 is configured, for example, in a housing of the axial piston machine 2. The pilot valve 14 furthermore has a tank connector T which by way of a tank line 30 is connected to a tank. The pilot valve 14 moreover has an operation connector A which is connected to a control chamber 32 of an actuating cylinder 34. The control chamber 32 herein is delimited by a set piston 36 of the actuating cylinder. A swash plate of the axial piston machine 2 can in this instance be adjusted by way of the set piston 36. A displacement path of the set piston 36 is detected by a displacement transducer 38. Alternatively or additionally, a swivel angle of the swivel cradle of the axial piston machine 2 is detected on a pivot axle of the swivel cradle by way of a rotary magnetic sensor. The actual delivery volume or the actual displacement volume of the axial piston machine 2 can in this instance be determined by way of the detected path. The actual delivery volume 40 is then reported to the control 20. The pressure connector P in the initial position of the valve slide of the pilot valve 14 is connected to the operation connector A, and the tank connector T is blocked. When the valve slide is impinged with the actuating force of the actuator 16, the valve slide, proceeding from the initial position thereof, is moved in the direction of switched positions in which the pressure connector P is blocked and the operation connector A is connected to the tank connector T. The set piston 36 in the initial position of the valve slide of the pilot valve 14 is thus impinged with pressurizing medium from the pressure line 24. Furthermore provided in the adjusting mechanism 12 is a cylinder 42. The latter has a set piston 44 which engages on the swash plate of the axial piston machine 2. The set piston 44 limits a control chamber 46 which is connected to the pressure line 24. The set piston 44 by way of pressurizing medium of the control chamber 46 and by way of the spring force of a spring 48 is impinged in such a manner that said set piston 44 loads the swash plate in the direction of increasing the delivery volume.

Furthermore provided is a pressure sensor 50 by way of which the pressure in the pressure line 24 is detected and reported to the control 20, wherein the pressure is an actual outlet pressure 52. Moreover provided is a pressure sensor 54 which detects the highest actual load pressure (actual LS pressure) 56, the latter being transmitted to the control 20.

A control 57 by way of a CAN interface 58 is connected to the control 20, in particular for transmitting the actual rotating speed and one or a plurality of controller setpoint(s), such as for example the nominal outlet pressure, the nominal delivery volume or the nominal swivel angle, nominal output value or the nominal torque, to the control 20. It is also conceivable for the actual rotating speed 8 to be supplied directly to the control 20.

The position of the swash plate of the axial piston machine 2 in the use of the pressurizing medium supply assembly 1 is controlled by way of the pilot valve 14 and the set piston 36. A conveyed volumetric flow of the axial piston machine 2 is proportional to the position of the swash plate. The set piston 44 pre-loaded by the spring 48, or the counter piston, is at all times impinged by the actual outlet pressure or the pump pressure. In a non-rotating axial piston machine 2 and an adjusting mechanism 12 without pressure the swash plate by the spring 48 is kept in a position of +100 per cent. In a driven axial piston machine 2 and a non-energized actuator 16 of the pilot valve 14, the swash plate pivots to a zero-stroke pressure , since the set piston 38 is impinged with pressurizing medium of the pressure line 24. An equilibrium between an actual outlet pressure at the set piston 36 and the spring force of the spring 48 is established at a predetermined pressure or pressure range, for example between 8 to 12 bar. Said zero-stroke operation is assumed, for example, in the event of de-energized electronics or a de-energized control 20. The actuation of the pilot valve 14 takes place by way of the control 20, the latter being, for example, preferably digital electronics, alternatively analog electronics. The control 20 processes the required control signals, as is explained in more detail hereunder.

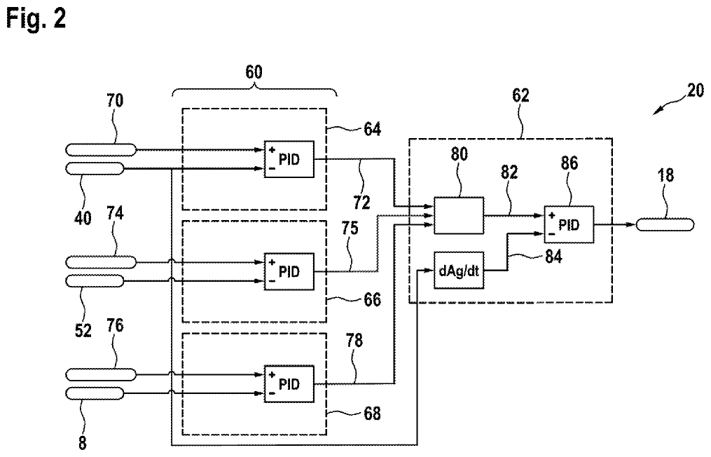

FIG. 2 schematically shows a functioning mode of the control 20. The latter has a first closed-loop control circuit 60 and a second closed-loop control circuit 62. The first closed-loop control circuit 60 has a control 64 for a swivel angle of the swash plate of the axial piston machine 2 from FIG. 1, a controller 66 for the outlet pressure of the axial piston machine 2, and a controller 68 for a torque of the axial piston machine 2. The controller 64 as input variables has a nominal delivery volume 70 and the actual delivery volume 40. A control variable 72 is provided as an output variable. The controller 66 as input variables has a nominal outlet pressure 74 and the actual outlet pressure 52. A control variable 75 is provided as an output variable. The controller 68 as input variables has an actual torque 76 or a nominal torque. The actual torque which in turn is able to be determined for example by means of a characteristics map by way of the actual rotating speed 8 and/or by way of the actual outlet pressure and/or by way of the actual swivel angle or actual delivery volume is provided as a further input variable. A control variable 78 is provided as an output variable for the controller 68. In the respective controller 64 to 68, the input variables are in each case applied to a control element in the form of a PID controller.

The control variables 72, 75 and 78 are supplied to a minimum value generator 80. The latter ensures that only the controller 72, 75 or 78 assigned to the desired operating point is automatically active. Either the outlet pressure, the torque, or the delivery volume herein is precisely controlled, wherein the respective two other variables are below a predefined nominal value. An output signal of the minimum value generator 80 in this instance is a nominal value in the form of a delivery-volume adjustment rate or a nominal delivery-volume adjustment rate 82 or nominal swivel-angle adjustment rate. The latter in this instance is an input variable for the second subordinate closed-loop control circuit 62. The derivation of the actual delivery volume 40 is a further input variable of the second closed-loop control circuit 62, said further input variables in this instance being an actual delivery-volume adjustment rate 84. The input variables 82 and 84 for the second closed-loop control circuit 62 are then supplied to a control element in the form of a PID element 86. The latter then emits the control variable 18 for the pilot valve 14 from FIG. 1.

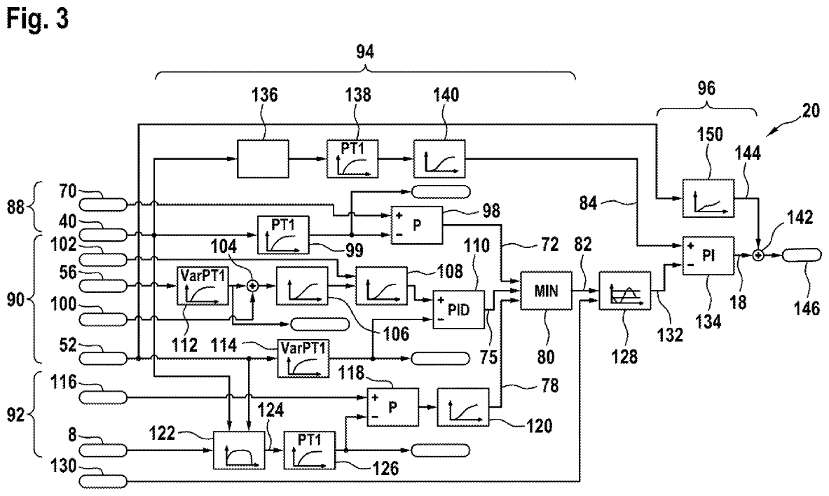

According to FIG. 3, a further embodiment for the control 20 from FIG. 1 is shown. Said further embodiment has a controller 88 for the delivery volume of the axial piston machine 2, cf. also FIG. 1. Furthermore provided are a controller 90 for the outlet pressure of the axial piston machine 2 and a controller 92 for the torque of the axial piston machine 2. This forms part of a first closed-control circuit 94. Furthermore provided so as to underlie the first closed-loop control circuit is a second closed-loop control circuit 96 for the delivery-volume adjustment rate or the swivel-angle adjustment rate of the axial piston machine 2.

The controller 88 has a control element 98 in the form of a P-element. The nominal delivery volume 70 and the actual delivery volume 40 are provided as input variables. The actual delivery volume 40 is supplied to the control element 98 by way of the filter in the form of a PT1 filter. The control variable 72 is provided as the output variable at the output side of the controller 88, said control variable 72 being supplied to the minimum value generator 80.

The controller 90 as input variables has the actual outlet pressure 52, the actual LS pressure 56, a nominal pressure differential 100 and a nominal pressure gradient 102. The actual LS pressure 56 and the nominal pressure differential 100 by way of a summing element 104 linked so as to form an nominal outlet pressure. The nominal outlet pressure is then supplied to a control element 106 in the form of an inverted PT1 element which estimates a predicted signal profile. The nominal outlet pressure is then furthermore supplied to a control element 108 which has the nominal pressure gradient 100 as a further input variable. The nominal pressure gradient 102 then predefines the maximum potential gradient which is to be provided. The nominal outlet pressure by way of the control element 108 is then influenced by the predefined nominal pressure gradient 102 in such a manner that the dynamic characteristic of the pressurizing medium supply assembly 1 from FIG. 1 can be controlled by the nominal pressure gradient 102.

For example, the influence can be such that the higher the nominal pressure gradient 102 the more rapidly the swash plate of the axial piston machine 2 is able to be adjusted. It conversely applies in this instance that the smaller the nominal pressure gradient the slower the swash plate of the axial piston machine 2 is adjusted. After the control element 108, the nominal outlet pressure is then supplied to a control element 110 in the form of a PID element. The actual outlet pressure 52 is then provided as a further input variable for the control element 110. The control variable 75 which is supplied to the minimum value generator 80 results as the output variable of the control element 110.

The actual LS pressure 56 of the controller 90 prior to the summing element 104 is supplied to a filter 112 which is a variable PT1 filter. The same applies to the actual outlet pressure which prior to the control element 110 is likewise supplied to a filter 114 in the form of a variable PT1 filter. The filters 112 and 114 have variable, in particular pressure-dependent, filter coefficients.

The controller 92 as input variables has the actual rotating speed 8, the actual delivery volume 40, the actual outlet pressure 52, and a nominal torque 116. The input variables are supplied to a control element 118 in the form of a P-element. The control variable 78 which is supplied to the minimum value generator 80 is provided as an output variable for the control element 118. A control element 120 which, as in the case of the control element 106, is an inverted PT1 filter is provided for the control variable 78 after the control element 118. Furthermore, the actual rotating speed, the actual delivery volume 40, and the actual outlet pressure 8, prior to being supplied to the control element 118, are supplied to a control element 122. The latter serves for calculating an actual torque 124 based on the actual rotating speed 8, on the actual delivery volume 40, and the actual outlet pressure 8. The calculation is performed by means of a characteristics map of the control element 122. The characteristics map is a function of the actual outlet pressure 52 which is supplied to the control element 122. The actual delivery volume 40 is furthermore supplied to the control element 122. The characteristics map in this instance can alternatively or additionally be a function of the actual delivery volume 40. In other words, the actual torque 124 is formed from the actual rotating speed 8 and from the actual outlet pressure 52 and/or from the actual delivery volume 40. The actual torque 124, prior to reaching the control element 118, is then subsequently supplied to a filter 126 in the form of a PT1 element.

Furthermore, the actual delivery volume 40, prior to being supplied to the control element 98, is supplied to a filter 99 in the form of a PT1 element.

The minimum value generator 80 from the control variables 72, 75 and 78 forms the nominal delivery-volume adjustment rate 82 or the nominal swivel-angle adjustment rate. The latter is supplied to a control element 128. The dynamic characteristic of the pressurizing medium supply assembly 1 can be influenced by said control element 128. To this end, a nominal delivery-volume adjustment rate 130 or a nominal swivel-angle adjustment rate, which is adjustable, is provided as a further input variable for the control element 128. For example, the nominal delivery-volume adjustment rate 82 or the nominal swivel-angle adjustment rate which is emitted from the minimum value generator 80 can be limited and/or influenced in such a manner by way of the nominal delivery-volume adjustment rate 130 or the nominal swivel-angle adjustment rate that the greater the variable 130 the faster the swash plate of the axial piston machine 2 can be pivoted and vice versa. The dynamic characteristic of the pressurizing medium supply assembly 1 can thus be influenced by adjusting the nominal delivery-volume adjustment rate 130 and/or by adjusting the nominal pressure gradient 102. On account thereof, the pressurizing medium supply assembly 1 can be adapted in a simple and cost-effective manner to different work machines and/or to different application conditions and/or to different specific applications, for example.

After the control element 128, the nominal delivery-volume adjustment rate 132 or the nominal swivel-angle adjustment rate as an input variable is supplied to the second closed-loop control circuit 96. The latter has a control element 134 in the form of a PI-element. The actual delivery-volume adjustment rate 84 or the actual swivel-angle adjustment rate is provided as a further input value for the control element 134. Said actual delivery-volume adjustment rate 84 or said actual swivel-angle adjustment rate is based on the actual delivery volume 40 which is derived in a control element 136. Thereafter, the derivation, thus the actual delivery-volume adjustment rate, is supplied to a filter 138 in the form of a PT1 filter. Prior to the actual variable 84 being supplied to the control element 134, a control element 140 in the form of an inverted PT1 filter is subsequently provided. The control element 134 of the second closed-loop control circuit 96 has the control variable 18 as the output variable for the pilot valve 14 from FIG. 1. Said control variable 18 is supplied to a summing element 142. A preliminary control value 144 is provided as a further input variable for the summing element 142. Said preliminary control value 144 is an output variable of a control element 150 which has the actual outlet pressure 52 as the input value. The preliminary control value 144 is then determined based on the actual outlet pressure 52. The summing element 142 then links the control variable 18 and the preliminary control value 144, a neutral current in the stationary operating state of the pilot valve being pre-controlled therewith. A pressure-dependent target of a neutral signal value for the pilot valve 14 from FIG. 1 is thus established. This has the advantage that the control 20 is relieved in terms of said control task. A final control variable 146 for the pilot valve 14 is then provided as an output variable of the summing element 142.

The preliminary control value 144 in the control element 150 can preferably be determined based on a model while taking into consideration flow forces at the pilot valve 14 and/or a magnet characteristic of the actuator 16 and/or of a control edge characteristic of the valve slide of the pilot valve 14 and/or of a spring stiffness of the valve spring 22.

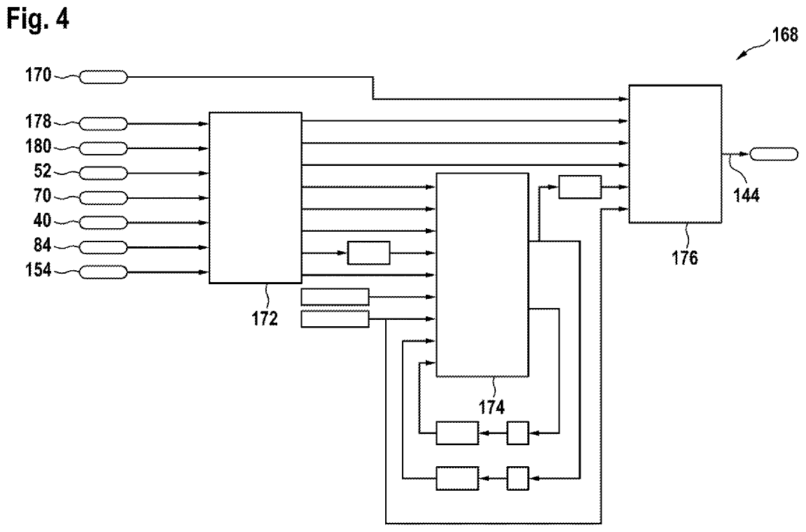

FIG. 4 schematically shows a control element 168. This can be provided as an alternative to the control element 150 from FIG. 3 for the second closed-loop control circuit 96. The preliminary control value or the preliminary control variable 144 is provided as an output variable. The control element 168 is able to be activated and deactivated by way of a switch 170. The control element 168 has an input block 172, a characteristics map block 174, and an output block 176. A nominal current 178 (see 146 in FIG. 3) can be provided as an input variable for the input block 172 when required. Furthermore, a nominal outlet pressure 180 (see 74 in FIG. 2) can be provided as an input variable. Said outlet pressure 180 is determined in a manner corresponding to the explanations according to FIG. 3, for example, or the nominal outlet pressure, additionally to the control element 110 (see FIG. 3), is supplied to the input block 172. The actual outlet pressure 52 (see also fib. 3) is provided as a further input variable for the input block 172. Alternatively, it is conceivable for the filtered actual outlet pressure after the filter 114 to be used as an input variable. The nominal delivery volume 70 or the nominal swivel angle can be provided as a further input variable. It is furthermore conceivable for the actual delivery volume 40 or the actual swivel angle to be used as an input variable. Moreover, the actual delivery-volume adjustment rate 84 or the actual swivel-angle adjustment rate can be provided as an input variable. The temperature 154 can likewise be used as an input variable. The stationary operating state in the characteristics map block 174 in which the actual delivery-volume adjustment rate 84 or the actual swivel-angle adjustment rate is zero is identified by means of one or a plurality of the input variables, in particular by means of the temperature 154 and/or by means of the actual outlet pressure 52 and/or by means of the actual delivery volume 40. A current characteristics map and/or an initial characteristics map is furthermore stored in the characteristics map block 174. It is determined whether the stationary operating state or operating point is on the characteristics map. If the operating point is not on the characteristics map, a point which is closest to the operating point is selected on the characteristics map, wherein said point in this instance is an interpolation point. If the operating point is on the characteristics map, the operating point in this instance is the interpolation point. If the operating point is spaced apart from the characteristics map, the characteristics map then is correspondingly updated such that the operating point is on the characteristics map again. The preliminary control value 144 at the output block 176 is determined by means of the updated characteristics map.

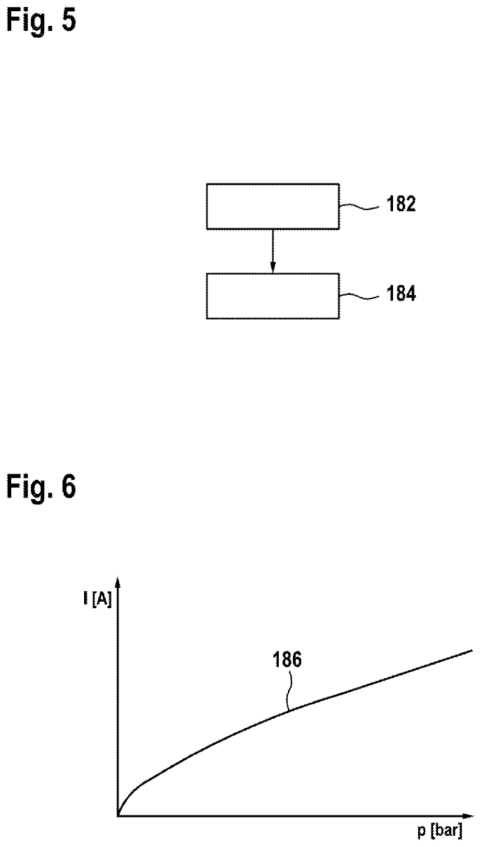

According to FIG. 5, the adaptation can take place in such a manner that in a step 182 the stationary operating state of the pressurizing medium supply assembly is determined by way of the control 20, as explained above (see FIG. 3). The determination herein takes place in such a manner that the actual delivery-volume adjustment rate 84 or the actual swivel-angle adjustment rate is zero. The signal proportion which in this case as an error is contributed by the control element 134 to the neutral current 144 or the preliminary control value 144 in step 184 is then subtracted as an error from the characteristics map or from the neutral current curve. The subtraction herein is performed from the interpolation point of the neutral current curve, thus from that point that corresponds to the stationary operating state or is closest to the latter. The characteristics map can be one-dimensional, for example be an actual outlet-pressure neutral-current characteristics map. A multi-dimensional characteristics map, for example with the actual outlet pressure, the actual temperature, and the actual rotating speed, is also conceivably provided.

FIG. 6 in an exemplary manner shows a characteristics map in the form of a neutral current curve 186. The neutral current I herein is a function of the actual outlet pressure p. The neutral current I herein increases along with an increasing actual outlet pressure p, and vice versa. It would also be conceivable for the neutral current I to decrease along with an increasing actual outlet pressure p, and vice versa.

What is claimed is:

1. A hydraulic pressurizing medium supply assembly for an open hydraulic circuit, comprising:
a hydro machine;
an adjusting mechanism including (i) an actuating cylinder having a set piston configured to adjust a delivery volume of the hydro machine, and (ii) a pilot valve electrically actuatable in a proportional manner, wherein an inflow to and/or an outflow via the pilot valve from a control chamber of the actuating cylinder that is limited by the set piston is configured for control in order for an actuation of the set piston to be impinged with pressurizing medium; and
an electronic control including a controller having an output variable that is a control variable for the pilot valve,
wherein at a specific neutral current a valve slide of the pilot valve assumes a position in which the set piston does not perform any movement, and
wherein at an output side of the controller, a preliminary control variable for the specific neutral current is linked with the control variable for the pilot valve in order for the control variable for the pilot valve to be set.

2. The hydraulic pressurizing medium supply assembly according to claim 1, wherein the controller includes a control element configured to determine the preliminary control variable based on a characteristics map.

3. The hydraulic pressurizing medium supply assembly according to claim 2, wherein at least one operating variable of the hydraulic pressurizing medium supply assembly is included as an input variable for the control element.

4. The hydraulic pressurizing medium supply assembly according to claim 2, wherein the characteristics map and/or the preliminary control variable are/is adaptable.

5. The hydraulic pressurizing medium supply assembly according to claim 3, wherein at least one of an actual outlet pressure of the hydro machine, an actual rotating speed of the hydro machine, an actual temperature of the pressurizing medium, and an actual delivery volume of the hydro machine are/is provided as the at least one operating variable.

6. The hydraulic pressurizing medium supply assembly according to claim 1, wherein:
the controller is configured to control an actual swivel-angle adjustment rate of the hydro machine,
the controller as an input variable having the actual swivel-angle adjustment rate and a nominal swivel-angle adjustment rate of the hydro machine, and as an output variable having the control variable for the pilot valve.

7. A method for operating a hydraulic pressurizing medium supply assembly, comprising:
linking (i) a preliminary control variable for a specific neutral current, and (ii) a control variable for a pilot valve in order to set the control variable for the pilot valve,
wherein the hydraulic pressurizing medium supply assembly is for an open hydraulic circuit,
wherein the hydraulic pressurizing medium supply assembly includes:
a hydro machine;
an adjusting mechanism including (i) an actuating cylinder having a set piston configured to adjust a delivery volume of the hydro machine, and (ii) the pilot valve electrically actuatable in a proportional manner, wherein an inflow to and/or an outflow via the pilot valve from a control chamber of the actuating cylinder that is limited by the set piston is configured for control in order for an actuation of the set piston to be to impinged with pressurizing medium; and
an electronic control including a controller having an output variable that is the control variable of the pilot valve,
wherein at the specific neutral current a valve slide of the pilot valve assumes a position in which the set piston does not perform any movement.

8. The method according to claim 7, further comprising:
determining a stationary operating state of the hydraulic pressurizing medium supply assembly by way of the electronic control; and
adapting the preliminary control variable and/or a characteristics map based on the stationary operating state,
wherein the controller includes a control element configured to determine the preliminary control variable based on the characteristics map.

9. The method according to claim 8, wherein the adapting of the preliminary control variable and/or the characteristics map takes place in such a manner that in the stationary operating state the control variable for the pilot valve in a central position of the valve slide of the pilot valve is zero.

10. The method according to claim 8, wherein an actual swivel-angle adjustment rate of the hydro machine in the stationary operating state is zero.

11. The method according to claim 10, wherein, should the control variable of the pilot valve in the stationary operating state deviate from zero and thus as an error value be controlled in addition to the specific neutral current, the control variable as an error value is offset against the preliminary control variable and/or against the characteristics map in such a manner that the preliminary control variable and/or the characteristics map are/is adapted or updated on account thereof

12. The method according to claim 11, wherein a subtraction of the control variable as an error value from the preliminary control variable and/or the characteristics map is provided as an offset.
